(19) United States
(12) Patent Application Publication
(10) Pub. No.: US 2023/0168384 A1
(43) Pub. Date: Jun. 1, 2023

(54) METHODS AND APPARATUS FOR MONITORING THE QUALITY OF CORRECTON DATA ASSOCIATED WITH A NAVIGATION SATELLITE OR THE PROPAGATION OF SIGNALS TRANSMITTED THEREBY

(71) Applicant: HERE GLOBAL B.V., Eindhoven (NL)

(72) Inventors: Saara KUISMANEN, Tampere (FI); Pekka-Henrik NIEMENLEHTO, Nokia (FI)

(73) Assignee: HERE GLOBAL B.V., Eindhoven (NL)

(21) Appl. No.: 17/538,223

(22) Filed: Nov. 30, 2021

(51) Int. Cl. G01S 19/07; G01S 19/52; G01S 19/55

(52) U.S. Cl. CPC G01S 19/072; G01S 19/52; G01S 19/55

(57) ABSTRACT

A method, apparatus and computer program product monitor the quality of correction data. In a method, first parameter(s) associated with a navigation satellite or propagation of signals transmitted by the navigation satellite are predicted based upon prior data including prior correction data associated with the navigation satellite or the propagation of signals transmitted thereby. The method derives second parameter(s) associated with the navigation satellite or the propagation of signals transmitted thereby based upon second data including second correction data associated with the navigation satellite or the propagation of signals transmitted thereby. The second data including the second correction data is more recent than the prior data including the prior correction data. The method compares the first parameter(s) to the second parameter(s) and, based on the comparing, generates or provides information regarding the quality of the correction data.

### TECHNOLOGICAL FIELD

An example embodiment relates generally to monitoring the quality of correction data associated with a navigation satellite or the propagation of signals transmitted by the navigation satellite including, for example, monitoring the quality of correction data relating to the orbital coordinates, the velocity and/or the clock offset of the navigation satellite. In at least some example embodiments, the correction service may be alerted as to the quality of the correction data such that in an instance in which the correction data is of a low quality, the correction service may investigate the underlying cause of the low quality of the correction data and make any changes necessary to improve upon the quality of the correction data.

### BACKGROUND

Positioning and navigation solutions commonly depend upon a Global Navigation Satellite System (GNSS) with signals transmitted by a GNSS satellite being received by GNSS receivers embedded in or otherwise carried by a variety of different devices. For example, smartphones, smart watches, vehicles, drones and other location-aware devices include GNSS receivers in order to allow the position of the device to be determined. In some instances, the device may include a navigation system and/or a navigation application that is dependent upon the signals received by the GNSS receiver in order to determine the position of the device and to provide navigational assistance. The number of devices that include GNSS receivers is growing rapidly with more types of devices including devices, such as Internet of Things (IOT) devices, with limited amounts of computational resources including GNSS receivers.

The GNSS family includes several satellite constellations including the Global Positioning System (GPS) and the Globalnaya Navigatsionnaya Sputnikovaya Sistema (GLONASS) system. Other GNSS satellite constellations include the Beidou system and the Galileo system. In addition to these global satellite constellations, several regional Satellite-Based Augmentation Systems (SBAS), such as the Quasi-Zenith Satellite System (QZSS), Multifunctional Transport Satellites (MTSAT) Satellite Augmentation System (MSAS), Wide Area Augmentation System (WAAS), European Geostationary Navigation Overlay Service (EGNOS), GPS-Aided Geostationary (GEO) Augmented Navigation (GAGAN), System for Differential Correction and Monitoring (SDCM) and the Indian Regional Navigation Satellite System (IRNSS) having an operational name of NavIC (Navigation with Indian Constellation), have been developed.

In a GNSS system, a navigation satellite orbiting the Earth transmits navigation signals including ranging codes and navigation data interleaved with the ranging codes that a GNSS receiver receives and utilizes to determine the position of the GNSS receiver and, in turn, the device in which the GNSS receiver is embedded. The ranging code allows the GNSS receiver to determine the time required for the signals to travel from the navigation satellite to the GNSS receiver, which correlates to the distance between the navigation satellite and the GNSS receiver. The navigation data includes a set of parameter values of an orbit model defining the orbit of the navigation satellite for a limited period of time. The parameter values provide navigation data known as ephemeris data. The ephemeris data may be utilized by the GNSS receiver to determine the position the navigation satellite relative to a predefined coordinate system at particular instances of time. Based on the positions of a plurality of navigation satellites, the clock information of the navigation satellites, such as the clock offsets of the navigation satellites relative to GNSS time, and the time required for the signals broadcast by the navigation satellites to be received by the GNSS receiver, the GNSS receiver is configured to determine its position.

A GNSS receiver that relies solely upon signals received from navigation satellites may not be capable of determining its position with sufficient accuracy and/or in a sufficiently rapid manner in certain situations. In this regard, GNSS was originally designed for outdoor applications in which a GNSS receiver could continuously receive signals from the navigation satellites. However, in instances in which the signal conditions between a navigation satellite and a GNSS receiver are weak, such as in urban areas and, more particularly, within urban canyons, the position of the GNSS receiver may not be able to be accurately determined. Additionally, the time-to-first-fix (TTFF), that is, the time required for a GNSS receiver to initially determine its position based upon signals received from a navigation satellite may be longer than desired for certain applications, such as a navigation application that demands the relatively timely determination of position.

In order to improve upon the performance of a GNSS receiver in relation to the accuracy and timeliness with which the position of the GNSS receiver is determined, assisted-GNSS technology was developed. In this regard, assisted-GNSS recognizes that the ranging codes transmitted by a navigation satellite would generally be received by a GNSS receiver, even in relatively weak signal conditions, but that the navigation data interleaved with the ranging codes may become too noisy and erroneous for successful demodulation in certain circumstances, such as in an urban environment. As such, assisted-GNSS technology utilizes a global monitoring network for capturing the navigation data transmitted by navigation satellites and for providing at least some of the navigation data to a GNSS receiver as assistance data, such as via the Internet or other terrestrial communication systems or networks. In one example, an assisted GNSS Positioning service may provide GNSS assistance data, such as via, e.g., the HERE GNSS API from HERE Technologies that provides correction and assistance data including predicted assistance data.

Assistance data generally includes a set of information elements carrying information identifying a reference location and a reference time as well as navigation data from a navigation satellite. Access to the assistance data and potentially to additional information, such as the reference frequency of a modem utilized by the GNSS receiver, by the GNSS receiver may improve the performance of the GNSS receiver. For example, the availability of assistance data may permit the time-to-first-fix to be reduced, such as to about 5 to 10 seconds, for a position determination having an accuracy of about 5 meters in contrast to a time-to-first-fix that may be in a range of about 30 to 40 seconds for a GNSS receiver without assistance data. Recognizing the importance of assistance data to GNSS performance, the lifetime of assistance data has been extended and the assistance data has become more readily available to GNSS receivers, both in the form of online assistance data as well as offline assistance data. In this regard, offline assistance data can be utilized even in instances in which there would otherwise have been a delay in establishing a network connection to obtain online assistance data or an inability to establish a network connection to obtain online assistance data, such as in an instance in which the requisite roaming data plan is not available.

The ephemeris data that defines the orbit model has a certain, limited lifetime, such as 2 to 4 hours, during which the parameter values are valid and the position of the satellite can be estimated based thereupon with a desired accuracy. Following the transmission of the ephemeris data, the accuracy with which the position of the navigation satellite is defined by the parameter values decreases as the age of the ephemeris data for the satellite increases. Eventually, the GNSS receiver must receive a new set of ephemeris data for the navigation satellite if the position of the GNSS receiver is to be determined with sufficient accuracy. However, the acquisition of ephemeris data from the navigation satellite may be a time-consuming process taking up to several minutes or may require substantial network access.

As a result, an Ephemeris Extension Service (EES) is available to extend the useful lifespan of the ephemeris data with the extension based on a model of the orbit of the navigation satellite and, in some instances, the clock on-board of the navigation satellite. In a typical EES system, the orbit of a satellite is predicted by integrating output values of an equation of motion defined for the satellite. The last reliable position of the satellite that can be determined with the ephemeris data may be utilized as an initial state of the orbit for the integration. The predictions of the orbit of a satellite provided by an EES can be formatted in various manners including as a continuous polynomial function, such as a spline or Hermitea polynomial function, as a piecewise continuous function or as a delta or differential correction to the broadcast ephemeris data or almanac, etc. The equation of motion may be referenced as a force model, as the equation is based on forces acting upon the satellite. Although the orbit of the satellite may be predicted most accurately by including all forces that have a distinguishable effect upon the satellite, the equation of motion generally includes only the forces that contribute most significantly to the position of the satellite, such as by including the gravitational forces of the earth, the sun and the moon, as well as solar radiation pressure.

Several Ephemeris Extension Services are available including the ephemeris extension technology included in the 3rd Generation Partnership Project (3GPP) standards beginning with Release 8 and available for GPS, GLONASS and Galileo systems. This ephemeris extension technology provides differential corrections to a reference ephemeris. In addition, other types of Ephemeris Extension Services that are available include those provided by the HERE GNSS API from HERE Technologies as well as GPSOneXtra from Qualcomm Technologies, Inc., Long-Term Orbit (LTO) from Broadcom Inc. and Predicted GPS (PGPS) from RX Networks, Inc. These other types of Ephemeris Extension Services also allow the ephemeris lifetime to be extended, such as for several days or even weeks.

Techniques for improving the performance of GNSS-based positioning have also been developed including differential GNSS (d-GNSS), real-time-kinematic technology (RTK) and precise point positioning (PPP), as well as techniques that combine other positioning sources to improve performance such as inertial sensor integration, and the analysis of Wi-Fi or Bluetooth signals. With respect to PPP, for example, different types of corrections are computed on the basis of data collected by a network of reference stations. The correction data includes corrections for one or more of satellite orbits and clocks, code biases, ionospheric models and tropospheric models. A correction service may then transmit the correction data to navigation devices via a network connection. The navigation devices, in turn, can more accurately predict the position of a navigation satellite at different points in time and/or the propagation of signals transmitted by a navigation satellite by taking into account the correction data. However, the accuracy of the predictions of the position of a navigation satellite beyond the lifetime of the ephemeris data that are provided by ephemeris extension is increasingly diminished as more time passes since the expiration of the lifetime of the most recent ephemeris data.

At least some types of correction data are generated by a correction service and transmitted to navigation devices on a frequent basis. For example, correction data related to orbital corrections and corrections involving the clock offset of a navigation satellite may be provided by a correction service frequently, such as every 5 to 30 seconds.

While correction data is useful for improving the accuracy of the navigation data broadcast by navigation satellites, issues may arise in an instance in which the correction data is of poor quality. In this regard, correction data having a poor quality may not serve to increase the accuracy of the navigation data and, in some instances, may actually diminish the accuracy of the navigation data. However, monitoring the quality of the correction data in real time in order to identify correction data of a relatively low quality prior to utilizing the correction data in combination with the navigation data is challenging in light of the frequency with which at least some types of correction data is generated. In an effort to monitor the quality of the correction data in real time, techniques have been considered that utilize both correction data and navigation data that has been received by reference stations at predefined location. However, access to the navigation data received by reference stations in real time may not always be available and, even if available, the assessment of the quality of the correction data relating to orbital coefficients and the clock offset of a navigation satellite continues to be challenging since access to the code biases and the ionospheric and tropospheric models is also preferable in order remove the effect of these other potential sources of error.

Although not in real time, the quality of correction data can be monitored by utilizing post processing techniques. Although the post-processing techniques may identify correction data that is of low quality, the lower quality correction data may have already be utilized in combination with navigation data to determine the location of a navigation device, thereby potentially increasing the error associated with the location determination.

### BRIEF SUMMARY

A method, apparatus and computer program product are provided in accordance with an example embodiment in order to monitor the quality of correction data, such as in real time or near real time. As such, correction data that is determined to be of a poor quality need not be utilized in an effort to improve the accuracy of the navigation data. Additionally, the method, apparatus and computer program product of an example embodiment may provide an indication of the quality of the correction data, such as to navigation devices or other clients of a correction service, such that various remedial actions may be taken, such as by relying upon other correction data such as correction data obtained from a different correction service or the most recent correction data for the same navigation satellite that was determined to be of sufficient quality, eliminating consideration of navigation data provided by the navigation satellite for which the correction data is determined to be of low quality for purposes of determining the location of a navigation device and, instead, determining the location of the navigation device based upon the navigation data provided by other navigation satellites, such as other navigation satellites having correction data that has been determined to be of higher quality, etc. In at least some example embodiments, the method, apparatus and computer program product are configured to alert the correction service as to the quality of the correction data such that the correction service may investigate the underlying cause of correction data that is identified to be of low quality and may make changes to improve upon the quality of the correction data. By monitoring the quality of the correction data and relying upon only correction data that is determined to be of sufficient quality to improve the accuracy of the navigation data, the method, apparatus and computer program product of an example embodiment may increase the confidence in the correction data and, as a result, increase the confidence in the location of a navigation device that is determined utilizing the correction data.

In an example embodiment, a method is provided for monitoring a quality of correction data. The method includes predicting one or more of first orbital coordinates, a first velocity or a first clock offset of a navigation satellite based upon prior navigation data and prior correction data. The method also includes deriving one or more of second orbital coordinates, a second velocity or a second clock offset of the navigation satellite based upon second navigation data and second correction data. The second navigation data and second correction data are more recent than the prior navigation data and prior correction data. The method further includes comparing at least one of the first orbital coordinates, the first velocity or the first clock offset to at least one of the second orbital coordinates, the second velocity or the second clock offset, respectively. Based on the comparing, the method additionally includes generating or providing information regarding the quality of the correction data.

The prior navigation data and the prior correction data may be associated with a first time. In this example embodiment, predicting one or more of the first orbital coordinates, the first velocity or the first clock offset includes predicting one or more of the first orbital coordinates, the first velocity or the first clock offset for a time subsequent to the first time. In an example embodiment, the at least one of the first orbital coordinates, the first velocity or the first clock offset are predicted for the same time for which the one or more of the second orbital coordinates, the second velocity or the second clock offset are derived. In regards to the comparison, the method of an example embodiment compares one or more of a difference between the first and second orbital coordinates, a difference between the first and second velocities or a difference between the first and second clock offsets to respective thresholds. In an instance in which the difference between the first and second orbital coordinates, the difference between the first and second velocities or the difference between the first and second clock offsets fails to satisfy the respective threshold, the method of this example embodiment generates or provides information by providing the information regarding the quality of the correction data to a correction service that provides the first and second correction data.

In another example embodiment, an apparatus is provided that is configured to monitor a quality of correction data. The apparatus includes processing circuitry and at least one non-transitory memory including computer program code instructions stored therein with the computer program code instructions configured to, when executed by the processing circuitry, cause the apparatus at least to predict one or more of first orbital coordinates, a first velocity or a first clock offset of a navigation satellite based upon prior navigation data and prior correction data. The computer program code instructions are also configured to, when executed by the processing circuitry, cause the apparatus to derive one or more of second orbital coordinates, a second velocity or a second clock offset of the navigation satellite based upon second navigation data and second correction data. The second navigation data and second correction data are newer than the prior navigation data and prior correction data. The computer program code instructions are further configured to, when executed by the processing circuitry, cause the apparatus to compare at least one of the first orbital coordinates, the first velocity or the first clock offset to at least one of the second orbital coordinates, the second velocity or the second clock offset, respectively. Based on a comparison of the at least one of the first orbital coordinates, the first velocity or the first clock offset to the at least one of the second orbital coordinates, the second velocity or the second clock offset, respectively, the computer program code instructions are configured to, when executed by the processing circuitry, cause the apparatus to generate or provide information regarding the quality of the correction data.

The prior navigation data and the prior correction data may be associated with a first time. In this example embodiment, the computer program code instructions are configured to, when executed by the processing circuitry, cause the apparatus to predict one or more of the first orbital coordinates, the first velocity or the first clock offset for a time subsequent to the first time. In an example embodiment, the at least one of the first orbital coordinates, the first velocity or the first clock offset are predicted for the same time for which the one or more of the second orbital coordinates, the second velocity or the second clock offset are derived. The computer program code instructions are configured to, when executed by the processing circuitry, cause the apparatus of an example embodiment to compare by comparing one or more of a difference between the first and second orbital coordinates, a difference between the first and second velocities or a difference between the first and second clock offsets to respective thresholds. In this example embodiment, the computer program code instructions are configured to, when executed by the processing circuitry, cause the apparatus to, in an instance in which the difference between the first and second orbital coordinate, the difference between the first and second velocities or the difference between the first and second clock offsets fails to satisfy the respective threshold, generate or provide information by providing the information regarding the quality of the correction data to a correction service that provides the first and second correction data.

In a further example embodiment, a computer program product is provided that is configured to monitor a quality of correction data. The computer program product includes at least one non-transitory computer-readable storage medium having computer-executable program code instructions stored therein with the computer-executable program code instructions including program code instructions configured to predict one or more of first orbital coordinates, a first velocity or a first clock offset of a navigation satellite based upon prior navigation data and prior correction data. The computer-executable program code instructions also include program code instructions configured to derive one or more of second orbital coordinates, a second velocity or a second clock offset of the navigation satellite based upon second navigation data and second correction data. The second navigation data and second correction data are more recent than the prior navigation data and prior correction data. The computer-executable program code instructions further include program code instructions configured to compare at least one of the first orbital coordinates, the first velocity or the first clock offset to at least one of the second orbital coordinates, the second velocity or the second clock offset, respectively. Based on the comparing, the computer-executable program code instructions additionally include program code instructions configured to generate or provide information regarding the quality of the correction data.

The prior navigation data and the prior correction data may be associated with a first time. In this example embodiment, the program code instructions configured to predict one or more of the first orbital coordinates, the first velocity or the first clock offset include program code instructions configured to predict one or more of the first orbital coordinates, the first velocity or the first clock offset for a time subsequent to the first time. In an example embodiment, the at least one of the first orbital coordinates, the first velocity or the first clock offset are predicted for the same time for which the one or more of the second orbital coordinates, the second velocity or the second clock offset are derived. In regards to the comparison, the program code instructions of an example embodiment are configured to compare one or more of a difference between the first and second orbital coordinates, a difference between the first and second velocities or a difference between the first and second clock offsets to respective thresholds. In an instance in which the difference between the first and second orbital coordinates, the difference between the first and second velocities or the difference between the first and second clock offsets fails to satisfy the respective threshold, the program code instructions of this example embodiment that are configured to generate or provide information include program code instructions configured to provide the information regarding the quality of the correction data to a correction service that provides the first and second correction data.

In yet another example embodiment, an apparatus is provided for monitoring a quality of correction data. The apparatus includes means for predicting one or more of first orbital coordinates, a first velocity or a first clock offset of a navigation satellite based upon prior navigation data and prior correction data. The apparatus also includes means for deriving one or more of second orbital coordinates, a second velocity or a second clock offset of the navigation satellite based upon second navigation data and second correction data. The second navigation data and second correction data are more recent than the prior navigation data and prior correction data. The apparatus further includes means for comparing at least one of the first orbital coordinates, the first velocity or the first clock offset to at least one of the second orbital coordinates, the second velocity or the second clock offset, respectively. Based on the comparing, the apparatus additionally includes means for generating or providing information regarding the quality of the correction data.

The prior navigation data and the prior correction data may be associated with a first time. In this example embodiment, the means for predicting one or more of the first orbital coordinates, the first velocity or the first clock offset includes means for predicting one or more of the first orbital coordinates, the first velocity or the first clock offset for a time subsequent to the first time. In an example embodiment, the at least one of the first orbital coordinates, the first velocity or the first clock offset are predicted for the same time for which the one or more of the second orbital coordinates, the second velocity or the second clock offset are derived. In regards to the comparison, the apparatus of an example embodiment includes means for comparing one or more of a difference between the first and second orbital coordinates, a difference between the first and second velocities or a difference between the first and second clock offsets to respective thresholds. In an instance in which the difference between the first and second orbital coordinates, the difference between the first and second velocities or the difference between the first and second clock offsets fails to satisfy the respective threshold, the means for generating or providing information may include means for providing the information regarding the quality of the correction data to a correction service that provides the first and second correction data.

In an example embodiment, a method is provided for monitoring a quality of correction data. The method includes predicting one or more first parameters associated with a navigation satellite or propagation of signals transmitted by the navigation satellite based upon prior data including prior correction data associated with the navigation satellite or the propagation of signals transmitted by the navigation satellite. The method also includes deriving one or more second parameters associated with the navigation satellite or the propagation of signals transmitted by the navigation satellite based upon second data including second correction data associated with the navigation satellite or the propagation of signals transmitted by the navigation satellite. The second data including the second correction data is more recent than the prior data including the prior correction data. The method further includes comparing at least one of the one or more first parameters to at least one of the one or more second parameters and, based on the comparing, generating or providing information regarding the quality of the correction data.

The one or more first parameters may include one or more of first orbital coordinates, a first velocity or a first clock offset of the navigation satellite based upon prior navigation data and the prior correction data. In this example embodiment, the one or more second parameters may include one or more of second orbital coordinates, a second velocity or a second clock offset of the navigation satellite based upon second navigation data and the second correction data. In another example embodiment, the first and second correction data include correction data for one or more of orbit corrections, clock corrections, code bias corrections, phase bias corrections, ionospheric model corrections or tropospheric model corrections. In an example embodiment in which the prior data including the prior correction data are associated with a first time, predicting one or more first parameters includes predicting one or more first parameters for a time subsequent to the first time. The at least one of the one or more first parameters that are compared to the at least one of the one or more second parameters may be predicted for the same time for which the one or more second parameters are derived. In an example embodiment, comparing includes comparing one or more of a difference between the first and second parameters to a respective threshold. In this example embodiment, in an instance in which the difference between the first and second parameters fails to satisfy the respective threshold, generating or providing information includes providing the information regarding the quality of the correction data to a correction service that provides the first and second correction data.

In another example embodiment, an apparatus is provided that is configured to monitor a quality of correction data. The apparatus includes processing circuitry and at least one non-transitory memory including computer program code instructions stored therein with the computer program code instructions configured to, when executed by the processing circuitry, cause the apparatus at least to predict one or more first parameters associated with a navigation satellite or propagation of signals transmitted by the navigation satellite based upon prior data including prior correction data associated with the navigation satellite or the propagation of signals transmitted by the navigation satellite. The computer program code instructions are also configured to, when executed by the processing circuitry, cause the apparatus to derive one or more second parameters associated with the navigation satellite or the propagation of signals transmitted by the navigation satellite based upon second data including second correction data associated with the navigation satellite or the propagation of signals transmitted by the navigation satellite. The second data including the second correction data is more recent than the prior data including the prior correction data. The computer program code instructions are further configured to, when executed by the processing circuitry, cause the apparatus to compare at least one of the one or more first parameters to at least one of the one or more second parameters and, based on the comparison, to generate or provide information regarding the quality of the correction data.

The one or more first parameters may include one or more of first orbital coordinates, a first velocity or a first clock offset of the navigation satellite based upon prior navigation data and the prior correction data. In this example embodiment, the one or more second parameters may include one or more of second orbital coordinates, a second velocity or a second clock offset of the navigation satellite based upon second navigation data and the second correction data. In another example embodiment, the first and second correction data include correction data for one or more of orbit corrections, clock corrections, code bias corrections, phase bias corrections, ionospheric model corrections or tropospheric model corrections. In an example embodiment in which the prior data including the prior correction data are associated with a first time, the computer program code instructions configured to, when executed by the processing circuitry, cause the apparatus to predict one or more first parameters include computer program code instructions configured to predict one or more first parameters for a time subsequent to the first time. The at least one of the one or more first parameters that are compared to the at least one of the one or more second parameters may be predicted for the same time for which the one or more second parameters are derived. In regards to the comparison, the computer program code instructions may be configured to, when executed by the processing circuitry, cause the apparatus of an example embodiment to compare one or more of a difference between the first and second parameters to a respective threshold. In this example embodiment, in an instance in which the difference between the first and second parameters fails to satisfy the respective threshold, the computer program code instructions are configured to, when executed by the processing circuitry, cause the apparatus to generate or provide information by providing the information regarding the quality of the correction data to a correction service that provides the first and second correction data.

In a further example embodiment, a computer program product is provided that is configured to monitor a quality of correction data. The computer program product includes at least one non-transitory computer-readable storage medium having computer-executable program code instructions stored therein with the computer-executable program code instructions including program code instructions configured to predict one or more first parameters associated with a navigation satellite or propagation of signals transmitted by the navigation satellite based upon prior data including prior correction data associated with the navigation satellite or the propagation of signals transmitted by the navigation satellite. The computer-executable program code instructions also include program code instructions configured to derive one or more second parameters associated with the navigation satellite or the propagation of signals transmitted by the navigation satellite based upon second data including second correction data associated with the navigation satellite or the propagation of signals transmitted by the navigation satellite. The second data including the second correction data is more recent than the prior data including the prior correction data. The computer-executable program code instructions further include program code instructions configured to compare at least one of the one or more first parameters to at least one of the one or more second parameters and, based on the comparison, to generate or provide information regarding the quality of the correction data.

The one or more first parameters may include one or more of first orbital coordinates, a first velocity or a first clock offset of the navigation satellite based upon prior navigation data and the prior correction data. In this example embodiment, the one or more second parameters may include one or more of second orbital coordinates, a second velocity or a second clock offset of the navigation satellite based upon second navigation data and the second correction data. In another example embodiment, the first and second correction data include correction data for one or more of orbit corrections, clock corrections, code bias corrections, phase bias corrections, ionospheric model corrections or tropospheric model corrections. In an example embodiment in which the prior data including the prior correction data are associated with a first time, the program code instructions configured to predict one or more first parameters include program code instructions configured to predict one or more first parameters for a time subsequent to the first time. The at least one of the one or more first parameters that are compared to the at least one of the one or more second parameters may be predicted for the same time for which the one or more second parameters are derived. In an example embodiment, the program code instructions configured to compare include program code instructions configured to compare one or more of a difference between the first and second parameters to a respective threshold. In this example embodiment, in an instance in which the difference between the first and second parameters fails to satisfy the respective threshold, the program code instructions configured to generate or provide information include program code instructions configured to provide the information regarding the quality of the correction data to a correction service that provides the first and second correction data.

In yet another example embodiment, an apparatus is provided for monitoring a quality of correction data. The apparatus includes means for predicting one or more first parameters associated with a navigation satellite or propagation of signals transmitted by the navigation satellite based upon prior data including prior correction data associated with the navigation satellite or the propagation of signals transmitted by the navigation satellite. The apparatus also includes means for deriving one or more second parameters associated with the navigation satellite or the propagation of signals transmitted by the navigation satellite based upon second data including second correction data associated with the navigation satellite or the propagation of signals transmitted by the navigation satellite. The second data including the second correction data is more recent than the prior data including the prior correction data. The apparatus further includes means for comparing at least one of the one or more first parameters to at least one of the one or more second parameters and, based on the comparing, means for generating or providing information regarding the quality of the correction data.

The one or more first parameters may include one or more of first orbital coordinates, a first velocity or a first clock offset of the navigation satellite based upon prior navigation data and the prior correction data. In this example embodiment, the one or more second parameters may include one or more of second orbital coordinates, a second velocity or a second clock offset of the navigation satellite based upon second navigation data and the second correction data. In another example embodiment, the first and second correction data include correction data for one or more of orbit corrections, clock corrections, code bias corrections, phase bias corrections, ionospheric model corrections or tropospheric model corrections. In an example embodiment in which the prior data including the prior correction data are associated with a first time, the means for predicting one or more first parameters includes means for predicting one or more first parameters for a time subsequent to the first time. The at least one of the one or more first parameters that are compared to the at least one of the one or more second parameters may be predicted for the same time for which the one or more second parameters are derived. In an example embodiment, the means for comparing includes means for comparing one or more of a difference between the first and second parameters to a respective threshold. In this example embodiment, in an instance in which the difference between the first and second parameters fails to satisfy the respective threshold, the means for generating or providing information includes means for providing the information regarding the quality of the correction data to a correction service that provides the first and second correction data.

### BRIEF DESCRIPTION OF THE DRAWINGS

Having thus described example embodiments of the present disclosure in general terms, reference will now be made to the accompanying drawings, which are not necessarily drawn to scale, and wherein:

FIG. 1 illustrates a system that can be configured to monitor the quality of correction data associated with a navigation satellite or signals transmitted by the navigation satellite including, for example, the quality of correction data relating to the orbital coordinates, the velocity and/or the clock offset of the navigation satellite in accordance with an example embodiment of the present disclosure;

FIG. 2 is a block diagram of an apparatus that may be specifically configured in accordance with an example embodiment of the present disclosure;

FIG. 3 is a flowchart illustrating the operations performed, such as by the apparatus of FIG. 2, in accordance with an example embodiment of the present disclosure;

FIG. 4 is a flowchart illustrating the operations performed, such as by the apparatus of FIG. 2, in accordance with one example embodiment of the present disclosure; and

FIG. 5 is a block diagram illustrating operations performed to monitor the quality of correction data in accordance with an example embodiment of the present disclosure.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

A method, apparatus and computer program product are provided in accordance with an example embodiment in order to monitor the quality of correction data. The correction data may be provided by a correction service and may be utilized in order to improve the accuracy of the navigation data provided by navigation satellites and/or by an assistance data service and/or the propagation of signals transmitted by the navigation satellites that is utilized in order to determine the location of a navigation device. By monitoring the quality of the correction data, such as in real time or near real time and, in any event, in advance of utilizing the correction data in combination with the navigation data in an effort to improve the quality of the navigation data, the method, apparatus and computer program product can facilitate the use of only correction data that is of sufficient quality in order to improve the accuracy of the navigation data and can avoid utilization of correction data that is determined to be of low quality. In this regard, the method, apparatus and computer program product of an example embodiment may provide an indication in an instance in which the correction data is determined to be of insufficient quality such that the correction service that provided the correction data and/or navigation devices or other clients that receive the correction data from the correction service may be alerted as to the lower quality of the correction data. As a result, the method, apparatus and computer program product of an example embodiment may reduce or eliminate instances in which lower quality correction data is utilized that fails to improve the accuracy of the navigation data and, in fact, may diminish the accuracy of the navigation data.

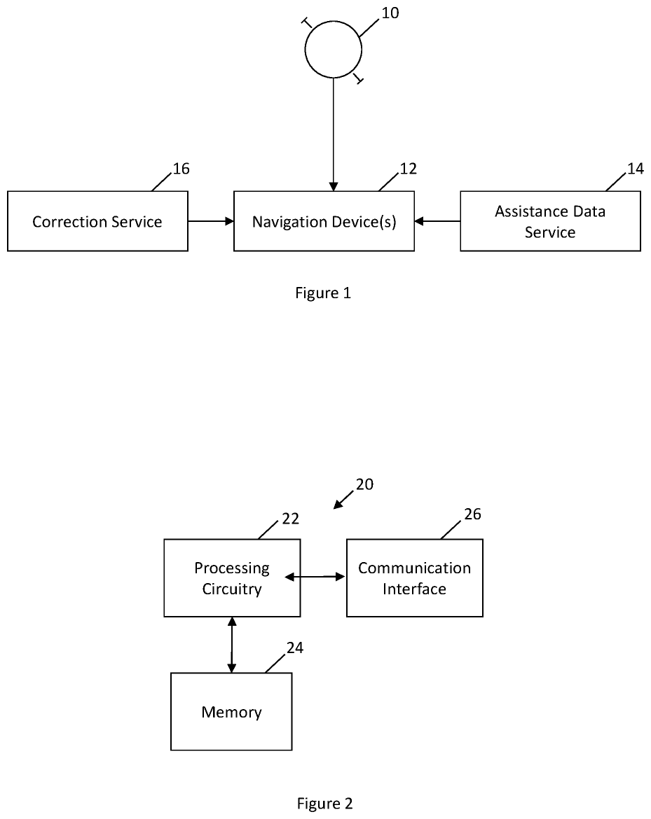

Referring now to FIG. 1, a navigation satellite 10 is depicted that broadcasts data including navigation data to one or more navigation devices 12. Although a single navigation satellite is depicted for purposes of illustration, the navigation satellite is typically one of a constellation of navigation satellites that orbit the earth. For example, the navigation satellite may be a GNSS satellite, such as a GPS satellite, a GLONASS satellite, a Beidou satellite, a Galileo satellite or a regional SPAS satellite. Regardless of the type of navigation satellite, the navigation satellite provides signals, such as on a periodic basis, that include a ranging code and ephemeris data interleaved with the ranging code that defines the orbit of the navigation satellite during the lifetime of the ephemeris data, such as for a predefined period of time, e.g., 2 to 4 hours. Based upon the ephemeris data, the position of the navigation satellite may be determined within the predefined period of time.

The navigation device 12 that receives the data, including the navigation data, broadcast by the navigation satellite 10 may include a receiver, such as a GNSS receiver, for receiving the signals transmitted by the navigation satellite. The navigation device may be embodied by any of a variety of devices including, for example, a mobile device, such as mobile terminal, e.g., a personal digital assistant (PDA), mobile telephone, smart phone, personal navigation device, smart watch, tablet computer or any combination of the aforementioned and other types of portable computing devices, or a positioning or navigation system such as a positioning or navigation system onboard a vehicle, e.g., an automobile, a truck, a drone, a train, a satellite. Although only a single navigation device is depicted in FIG. 1 for purposes of illustration, a plurality of navigation devices may receive the navigation data from the navigation satellite in other embodiments.

Based at least in part upon the navigation data, the position of the navigation satellite 10, such as the orbit and/or the clock offset of the navigation satellite, may be predicted at one or more points in time within a prediction interval. The prediction interval may extend temporally beyond a predefined period of time during which the ephemeris data is valid so as to predict the position of the navigation satellite at each of a plurality of points in time following the lifetime of the ephemeris data. Although the position of the navigation satellite may be predicted at the plurality of points in time within the prediction interval in any of a variety of different manners, the position of the navigation satellite may be predicted utilizing a prediction algorithm, such as a prediction algorithm that provides an ephemeris extension of the ephemeris data.

In addition to, or instead of receiving navigation data from the navigation satellite 10, the navigation device 12 may be configured to receive the navigation data from third party provider, such as an assistance data service 14 as shown in FIG. 1. Regardless of the source of the navigation data, such as the navigation satellite and/or the assistance data service, the navigation device may be configured to receive correction data from a correction service 16, such as via a network connection, with the correction data being combined with the navigation data in order to improve the accuracy of the navigation data. As a result, the location of the navigation device that is determined based upon the navigation data may be improved by determining the location based upon not only the navigation data, but also the correction data from the correction service.

In accordance with an example embodiment, an apparatus 20 is provided in order to monitor the quality of the correction data. In an example embodiment, the correction service 16 includes, is associated with or is otherwise in communication with the apparatus that is configured to monitor the quality of the correction data. In other example embodiments, however, the apparatus may be embodied a computing device, such as server, a router or the like, external to the correction service, but configured to receive the correction data from the correction service in order to monitor the quality thereof. Still further, the apparatus of other example embodiments may be embodied by the navigation device 12 or by a computing device associated with and in communication with the navigation device. Regardless of the manner in which the apparatus is embodied, the apparatus includes processing circuitry 22, a memory device 24 and a communication interface 26, as shown in FIG. 2.

In some embodiments, the processing circuitry 22 (and/or co-processors or any other processors assisting or otherwise associated with the processing circuitry) can be in communication with the memory device 24 via a bus for passing information among components of the apparatus 20. The memory device can be non-transitory and can include, for example, one or more volatile and/or non-volatile memories. In other words, for example, the memory device may be an electronic storage device (for example, a computer readable storage medium) comprising gates configured to store data (for example, bits) that can be retrievable by a machine (for example, a computing device like the processing circuitry). The memory device can be configured to store information, data, content, applications, instructions, or the like for enabling the apparatus to carry out various functions in accordance with an example embodiment of the present disclosure. For example, the memory device can be configured to buffer input data for processing by the processing circuitry. Additionally or alternatively, the memory device can be configured to store instructions for execution by the processing circuitry.

The processing circuitry 22 can be embodied in a number of different ways. For example, the processing circuitry may be embodied as one or more of various hardware processing means such as a processor, a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processing circuitry can include one or more processing cores configured to perform independently. A multi-core processor can enable multiprocessing within a single physical package. Additionally or alternatively, the processing circuitry can include one or more processors configured in tandem via the bus to enable independent execution of instructions, pipelining and/or multithreading.

In an example embodiment, the processing circuitry 22 can be configured to execute instructions stored in the memory device 24 or otherwise accessible to the processing circuitry. Alternatively or additionally, the processing circuitry can be configured to execute hard coded functionality. As such, whether configured by hardware or software methods, or by a combination thereof, the processing circuitry can represent an entity (for example, physically embodied in circuitry) capable of performing operations according to an embodiment of the present disclosure while configured accordingly. Thus, for example, when the processing circuitry is embodied as an ASIC, FPGA or the like, the processing circuitry can be specifically configured hardware for conducting the operations described herein. Alternatively, as another example, when the processing circuitry is embodied as an executor of software instructions, the instructions can specifically configure the processing circuitry to perform the algorithms and/or operations described herein when the instructions are executed. However, in some cases, the processing circuitry can be a processor of a specific device (for example, a computing device) configured to employ an embodiment of the present disclosure by further configuration of the processor by instructions for performing the algorithms and/or operations described herein. The processing circuitry can include, among other things, a clock, an arithmetic logic unit (ALU) and/or one or more logic gates configured to support operation of the processing circuitry.

The apparatus 20 of an example embodiment can also include the communication interface 26. The communication interface can be any means such as a device or circuitry embodied in either hardware or a combination of hardware and software that is configured to receive and/or transmit data from/to other electronic devices in communication with the apparatus, such as by providing for communication with the correction service 16 and/or a navigation device 12 or other client of the correction service. The communication interface can be configured to communicate in accordance with various wireless protocols including Global System for Mobile Communications (GSM), such as but not limited to Long Term Evolution (LTE). In this regard, the communication interface can include, for example, an antenna (or multiple antennas) and supporting hardware and/or software for enabling communications with a wireless communication network. Additionally or alternatively, the communication interface can include the circuitry for interacting with the antenna(s) to cause transmission of signals via the antenna(s) or to handle receipt of signals received via the antenna(s). In some environments, the communication interface can alternatively or also support wired communication.

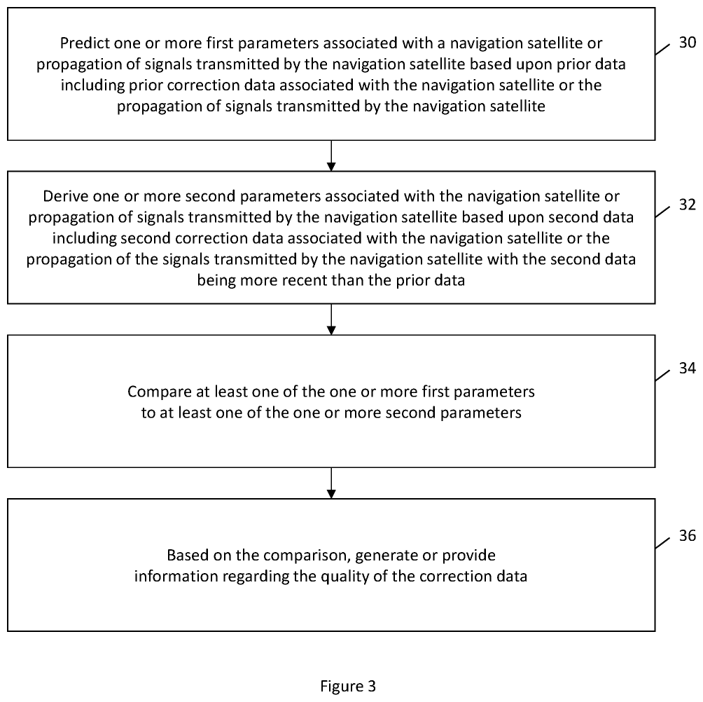

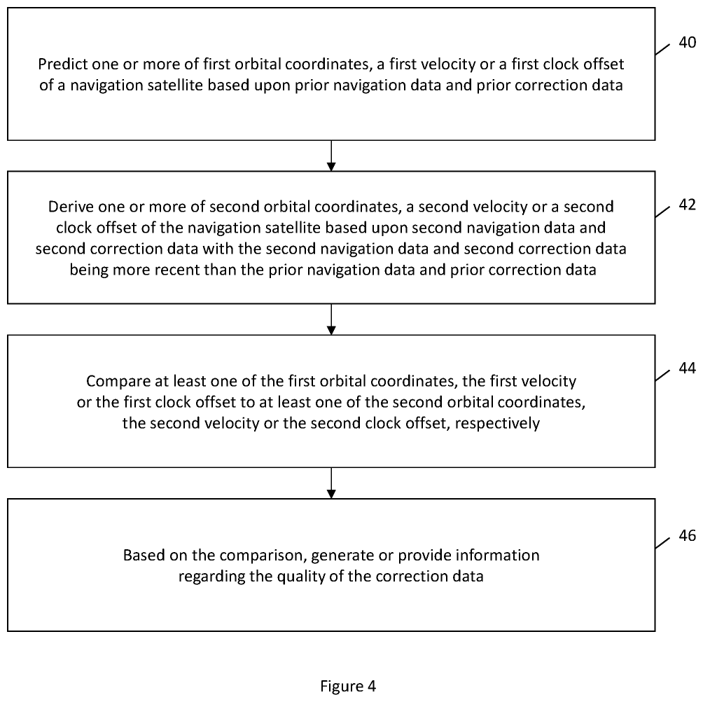

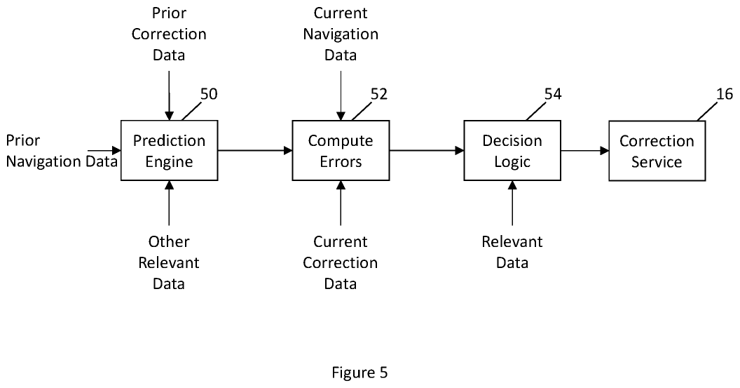

Referring now to FIG. 3, the operations performed by the apparatus 20 are depicted. As shown in block 30, the apparatus includes means, such as the processing circuitry 22 or the like, for predicting one or more first parameters associated with a navigation satellite 10 or the propagation of signals transmitted by the navigation satellite based upon prior data including prior correction data associated with the navigation satellite or the propagation of signals transmitted by the navigation satellite. The first parameter(s) that are predicted may include parameters associated with the navigation satellite, such as first orbital coordinates defining the position of the navigation satellite, the first velocity of the navigation satellite and/or a first clock offset of the navigation satellite, such as relative to the GNSS clock. As such and as shown in block 40 of FIG. 4, the apparatus of one example embodiment includes means, such as the processing circuitry or the like, for predicting one or more first orbital coordinates, the first velocity and/or the first clock offset based upon prior data including prior correction data associated with the navigation satellite or the propagation of signals transmitted by the navigation satellite. Additionally, or alternatively, the first parameter(s) that are predicted may include parameters associated with the propagation of signals transmitted by the navigation satellite, such as code biases, the ionospheric model, the tropospheric model or the like.

The prior data including the prior correction data upon which the first parameter(s) is predicted varies depending upon the type of first parameter, but is associated with the navigation satellite 10 or the propagation of signals transmitted by the navigation satellite regardless of the type of first parameter that is predicted. For example, in an instance in which the first parameter(s) that are predicted are first orbital coordinates, a first velocity or a first clock offset of the navigation satellite, the apparatus 20, such as the processing circuitry 22, of an example embodiment is configured to predict the first parameter(s) based upon prior navigation data, e.g., ephemeris data, provided by the navigation satellite as well as correction data for the particular parameter, such as correction data for the orbital coordinates, correction data for the velocity or correction data for the clock offset, provided, for example, by a correction service 16. Alternatively, in an instance in which the first parameter that is predicted is the code bias, the apparatus, such as the processing circuitry, of an example embodiment is configured to predict the code bias based upon prior data defining the code bias as well as correction data defining an error associated with the code bias. Similarly, in an instance in which the first parameter that is predicted is the ionospheric model and/or the tropospheric model, the apparatus, such as the processing circuitry, of an example embodiment is configured to predict the ionospheric model or the tropospheric model based upon prior data defining the ionospheric model or the tropospheric model as well correction data defining an error in the ionospheric model or the tropospheric model.

The apparatus 20, such as the processing circuitry 22, is configured to predict the first parameter(s) for a time that is subsequent to the time that is associated with the prior data including the prior correction data. By way of example, in relation to the prediction of first orbital coordinates, a first velocity and a first clock offset, the prior data, such as the prior navigation data, e.g., ephemeris data, is defined at or associated with time T₀, such as by valid at time T₀. Not only is the prior data, such as the prior navigation data, defined at or associated with time T₀, but the prior correction data is also defined for the same time T₀ so as to correct errors in the prior data, such as the navigation data, at time T₀. In contrast, however, the first parameter(s) that are predicted based upon the prior data, such as prior navigation data, including prior correction data from time T₀ are predicted so as to be valid at a time T₁ subsequent to time T₀.

By way of illustration, FIG. 5 illustrates a functional representation of the apparatus 20 and, more particularly, the processing circuitry 22 of the apparatus. In this example embodiment, a prediction engine 50 embodied by the apparatus, such as the processing circuitry, utilizes the prior navigation data and the prior correction data associated with time T₀ in order to predict one or more first parameters associated with the navigation satellite 10 or the propagation of signals transmitted by the navigation satellite at a subsequent time T₁. Prior to predicting the one or more first parameters, the prediction engine may be initialized with navigation and correction data, such as a set of matching positions, velocities and corrections for the satellite orbit and a set of matching clock offsets and corrections for the clock. In some embodiments, several sets of the navigation and correction data spanning a longer period of time may be utilized to initialize the prediction engine.

Once initialized, the prediction engine 50 is configured to predict one or more first parameters associated with the navigation satellite 10 or the propagation of signals transmitted by the navigation satellite at a time T₁ based upon the prior navigation data and the prior correction data associated with a prior time T₀ such as by propagating the prior navigation data and the prior correction data forward in time to time T₁. The prediction engine may be configured to predict one or more first parameters in various manners, such as by numerical integration in combination with a model of the behaviour of a parameter, such as a force model in regards to the orbital coordinates and/or velocity of a navigation satellite. The prediction engine may also be configured to optionally receive other relevant data that impacts the prediction of the first parameter(s). While various types of other relevant data may be considered by the prediction engine, examples of relevant data include information regarding the quality of the navigation data, information regarding the length of time over which the prediction was made (that is, the difference between time T₀ and time T₁), information regarding outages of one or more navigation satellites and/or data from other augmentation services that provide information regarding the navigation satellite and/or the propagation of signals transmitted by the navigation satellite. Other examples of relevant data that may be utilized in relation to the prediction of one or more first parameters include one or more of Earth orientation parameters, antenna phase center offsets or solar-radiation pressure parameters.

Referring now to block 32 of FIG. 3, the apparatus 20 also includes means, such as the processing circuitry 22 or the like, for deriving one or more second parameters associated with the navigation satellite 10 or the propagation of signals transmitted by the navigation satellite based upon second data, including second correction data, associated with the navigation satellite or the propagation of signals transmitted by the navigation satellite. Although a variety of different types of second parameters may be derived based upon a variety of types of second data, the second parameter(s) that are derived are generally the same type as the first parameter(s) that are predicted. For example, in an instance in which the first parameters that are predicted are the first orbital coordinates, the first velocity and/or the first clock offset based upon prior navigation data including prior correction data, the second parameters that are derived would similarly be second orbital coordinates, the second velocity and/or the second clock offset based upon second navigation data, including second correction data. As such and as shown in block 42 of FIG. 4, the apparatus of one example embodiment also includes means, such as the processing circuitry or the like, for deriving one or more second orbital coordinates, the second velocity and/or the second clock offset based upon second navigation data and second correction data. Similarly, in an instance in which the first parameters that are predicted are the code bias, the ionospheric model, and/or the tropospheric model, the second parameters that are derived are likewise the code bias, the ionospheric model, or the tropospheric model.

Although the second data that is utilized to derive the second parameter(s) is the same type of data as the prior data that is utilized to predict the first parameter(s), the second data, such as the second navigation data and the second correction data, is more recent (that is, is associated with a more recent time) than the prior data, such as prior navigation data and the prior correction data. For example, in an instance in which the second parameter(s) that are derived are the second orbital coordinates, the second velocity and/or the second clock offset, the second data, such as the second navigation data and the second correction data, upon which the derivation of the second parameter(s) is based is associated with and valid for a time subsequent to the time T₀ associated with the prior data, such as the prior navigation data and the prior correction data, that is utilized to predict the first parameter(s). Indeed, in an instance in which the first parameter(s) that are predicted are associated with and valid for a time T₁ subsequent to the time T₀ associated with the prior data, e.g., the prior navigation data and the prior correction data, the second parameter(s) that are derived are associated with the same time, that is, time T₁ as the time at which the predicted first parameter(s) are associated. Unlike the first parameter(s), however, that are predicted at time T₁ based upon older data, such as prior navigation data and prior correction data from a prior point in time T₀, the second parameter(s) are derived at time T₁ based upon more recent data, such as second navigation data and second correction data, from time T₁.

Referring now to block 34 of FIG. 3, the apparatus 20 also includes means, such as the processing circuitry 22 or the like, for comparing at least one of the one or more first parameters to at least one of the one or more second parameters. In an example embodiment and as shown in block 44 of FIG. 4, the apparatus includes means, such as the processing circuitry or the like, for comparing at least one of the first orbital coordinates, the first velocity or the first clock offset to at least one of the second orbital coordinates, the second velocity or the second clock offset, respectively. In other words, the apparatus, such as the processing circuitry, is configured to compare first and second parameters of the same type, such as by comparing first orbital coordinates to second orbital coordinates, the first velocity to the second velocity, the first clock offset to the second clock offset, the first clock offset to the second clock offset, the first code bias to the second code bias, the first ionospheric model to the second ionospheric model, or the first tropospheric model to the second tropospheric model.

In relation to the comparison of the first and second parameters, the apparatus 20, such as the processing circuitry 22, may be configured to determine the difference or error therebetween. By way of example of this comparison, FIG. 5 depicts the computation of an error between the first parameter(s) predicted by the prediction engine 50 and a corresponding second parameter that is derived based upon current navigation data and current correction data. See block 52. By computing the error, the difference between the first and second parameters is determined and is provided to decision logic 54. The decision logic of the apparatus, such as the processing circuitry, of this example embodiment is configured to determine the materiality of the error which, in turn, defines any subsequent action to be taken. Although the apparatus, such as the processing circuitry, may be configured to implement a wide variety of decision logic, the decision logic of one example embodiment defines a threshold against which the difference between the first and second parameters is compared. As such, the apparatus, such as the processing circuitry, of an example embodiment may be configured to determine whether the difference between the first and second parameters satisfies the threshold, such as by having a value that is less than the threshold.

Different thresholds may be defined for each different type of parameter, such as a positional threshold may be defined relative to the different between the first and second orbital coordinates, a velocity threshold may be defined with respect to the difference between the first and second velocities, a clock offset threshold may be defined with respect to the difference between the first and second clock offsets, a code bias threshold may be defined relative to the difference between the first and second code biases, an ionospheric model threshold may be defined with respect to the difference between the first and second ionospheric models and a tropospheric model threshold may be defined with respect to the difference between the first and second tropospheric models.

The respective thresholds may be predefined, such as in terms of a predefined magnitude of the difference between the first and second parameters, or a predefined percentage difference between the first and second parameters. Alternatively, the threshold may be adaptive. For example, an adaptive threshold may be defined based upon an estimation of one or more parameters of an error distribution of past errors.

The decision logic 54 may also be configured to optionally receive other relevant data that impacts the determination regarding the quality of the second correction data. While various types of other relevant data may be considered by the detection logic, examples of relevant data include information regarding the quality of the navigation data, information regarding the length of time over which the prediction was made (that is, the difference between time T₀ and time T₁), information regarding outages of one or more navigation satellites and/or data from other augmentation services that provide information regarding the navigation satellite and/or the propagation of signals transmitted by the navigation satellite. If considered, the other relevant data may, for example, be considered in conjunction with the establishment of the threshold against which the difference between the first and second parameters is compared.

As the first parameter(s) that are predicted based upon the prior data including the prior correction data are considered the acceptable standard against which the second parameter(s) that are derived based upon the second data including the second correction data are compared, the apparatus 20, such as the processing circuitry 22, of an example embodiment may be configured to validate the prior correction data prior to the prediction of the first parameter(s) and the comparison of the first and second parameters. The prior correction data may be validated in various manners. For example, the apparatus, such as the processing circuitry, may be configured to validate the prior correction data based upon information provided by an external validation source. Alternatively, the apparatus, such as the processing circuitry, may be configured to validate the prior correction data by utilizing second correction data that was determined to be of acceptable quality during a prior iteration of the foregoing process as the prior correction data during a subsequent iteration.

In an instance in which the difference between the first and second parameters satisfies the threshold such that the second correction data is determined to be of sufficiently high quality, the correction data provided by the correction service 16 may continue to be utilized in order to improve the accuracy of the navigation data and, in turn, the location of a navigation device 12 as defined based upon the navigation data. Satisfaction of the threshold may be defined in various manners. In one example embodiment, however, the threshold satisfied in an instance in which the first and second parameters are a close approximation of one another such that the difference between the first and second parameters is less than the threshold. Conversely, the threshold would not be satisfied in this example embodiment in which the first and second parameters are materially different from one another such that the difference between the first and second parameters equals or exceeds the threshold. As such, in an instance in which the difference between the first and second parameters are materially different from one another so as to fail to satisfy the threshold, the second correction data provided by the correction service is determined to be of low quality and the apparatus 20 of an example embodiment includes means, such as the processing circuitry 22, the communication interface 26, or the like, for generating and/or providing information regarding the quality of the correction data based upon the comparison of the first and second parameters. See block 36 of FIG. 3. In one example embodiment depicted in block 46 of FIG. 4, the apparatus includes means, such as the processing circuitry, the communication interface, or the like, for generating and/or providing information regarding the quality of the correction data based upon the comparison of the first orbital coordinates, the first velocity or the first clock offset to at least one of the second orbital coordinates, the second velocity or the second clock offset, respectively.

In some embodiments, the information regarding the quality of the correction data is provided following its determination, that is, following the comparison with a threshold, regardless of whether the correction data is determined to be of high quality or of low quality. However, the correction data that is determined to be of low quality may be flagged or otherwise identified so as to highlight the reduction in quality. The information regarding the quality of the correction data may be provided to various entities, either on a continuation basis or upon determining that an action is to be taken based upon the quality of the correction data. For example, the information regarding the quality of the correction data, such as the low quality of the correction data, may be provided to the correction service 16, which may, in turn, provide corresponding information regarding the quality of the correction data, such as the low quality of the correction data, to navigation devices 12 and other clients of the correction data provided by the correction service, such as by flagging the low quality correction data in order to inform the navigation devices and other clients of the low quality of the correction data. Additionally, or alternatively, the apparatus 20, such as the communication interface 26, may be configured to provide the information directly to one or more navigation devices or other clients of a correction service in order to inform the navigation devices or other clients of the correction service of the low quality of the correction data.

Based upon the information that is provided, various actions may be taken including, for example, a determination that a navigation satellite 10 is not performing properly. In an instance in which correction service 16 that is the source of the low quality correction data is informed as to the low quality correction data, the correction service may investigate the underlying cause of the low quality of the correction data in order to make any changes necessary to improve upon the quality of the correction data going forward. Additionally, or alternatively, a navigation device 12 may be configured not to utilize or to more lightly weight the correction data provided by the correction service that has been indicated to be of low quality. In this instance in which a navigation device does not utilize second correction data that has been determined to be of low quality, the navigation device may be configured to, instead, continue to utilize prior correction data, such as the prior correction data, that has been determined to be of higher quality in relation to the ongoing correction of the navigation data. Although the prior correction data is older and potentially less accurate, the prior correction data was at least determined to be of higher quality than the more recent correction data. Alternatively, a navigation device may discontinue the receipt of correction data from the correction service for which the correction data was determined to be of low quality and may, instead, be configured to receive correction data from a different correction service that is capable of providing higher quality correction data. Still further, a navigation device may transition to use of a different positioning technique or utilize single point positioning without correction, such as in an instance in which a significant amount of the correction data is determined to be of low quality.

The determination of the quality of the correction data for at least the navigation data is performed on a navigation satellite 10 by navigation satellite basis. Thus, the apparatus 20, such as the processing circuitry 22, is configured to repeat the process described above and depicted in FIGS. 3 and 4 for each of a plurality of navigation satellites, such as each of the plurality of navigation satellites with which a navigation device 12 communicates. As such, in an instance in which the correction data associated with one navigation satellite is determined to be of low quality, the correction data associated with the other navigation satellites with which the navigation device is in communication may be determined to be of sufficiently high quality. As such, the navigation device of this example embodiment may be configured to discontinue reliance upon the navigation satellite for which the associated correction data is of low quality and to, instead, rely on the navigation data provided by the other navigation satellites for which the correction data is of sufficient and higher quality.

Although described hereinabove in conjunction with an embodiment in which the first and second parameters relate to the orbital coordinates, velocity or clock offset of a navigation satellite 10 or the code bias, ionospheric model or tropospheric model associated with the propagation of signals from the navigation satellite, different types of first and second parameters may be predicted and derived, respectively, in other embodiments. For example, the first and second parameters may be the first and second correction data, respectively. Thus, differences between the first and second correction data itself may be determined by comparison and then utilized in order to determine if the quality of the second correction data is sufficient based upon the difference between the first and second correction data.

As described above, the method, apparatus 20 and computer program product are configured to monitor the quality of correction data, such as in real time or near real time and, in any event, prior to utilizing the correction data in combination with the navigation data in an effort to insure the quality of the correction data. As such, correction data that is determined to be of a poor quality need not be utilized so as to avoid any unintentional reduction in the accuracy of the navigation data. As a result, by monitoring the quality of the correction data and relying upon only correction data that is determined to be of sufficient quality to improve the accuracy of the navigation data, the method, apparatus and computer program product of an example embodiment may increase the confidence in the correction data and, as a result, increase the confidence in the location of a navigation device that is determined utilizing the correction data.

As described above, FIGS. 3 and 4 are flow diagrams of an apparatus 20, method, and computer program product configured to monitor the quality of correction data according to an example embodiment. It will be understood that each block of the flow diagrams, and combinations of blocks in the flow diagrams, may be implemented by various means, such as hardware, firmware, processing circuitry 22, and/or other devices associated with execution of software including one or more computer program instructions. For example, one or more of the procedures described above may be embodied by computer program instructions. In this regard, the computer program instructions which embody the procedures described above may be stored by the memory device 24 of the apparatus and executed by the processing circuitry or the like. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the blocks of the flow diagrams. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the blocks of the flow diagrams.

Accordingly, blocks of the flow diagrams support combinations of means for performing the specified functions and combinations of operations for performing the specified functions. It will also be understood that one or more blocks of the flow diagrams, and combinations of blocks in the flow diagrams, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method for monitoring a quality of correction data, the method comprising:
predicting one or more of first orbital coordinates, a first velocity or a first clock offset of a navigation satellite based upon prior navigation data and prior correction data;
deriving one or more of second orbital coordinates, a second velocity or a second clock offset of the navigation satellite based upon second navigation data and second correction data, wherein the second navigation data and second correction data are more recent than the prior navigation data and prior correction data;
comparing at least one of the first orbital coordinates, the first velocity or the first clock offset to at least one of the second orbital coordinates, the second velocity or the second clock offset, respectively; and
based on the comparing, generating or providing information regarding the quality of the correction data.

2. A method according to claim 1, wherein the prior navigation data and the prior correction data are associated with a first time, and wherein predicting one or more of the first orbital coordinates, the first velocity or the first clock offset comprises predicting one or more of the first orbital coordinates, the first velocity or the first clock offset for a time subsequent to the first time.

3. A method according to claim 1, wherein the at least one of the first orbital coordinates, the first velocity or the first clock offset are predicted for the same time for which the one or more of the second orbital coordinates, the second velocity or the second clock offset are derived.

4. A method according to claim 1, wherein the comparing comprises comparing one or more of a difference between the first and second orbital coordinates, a difference between the first and second velocities or a difference between the first and second clock offsets to respective thresholds.

5. A method according to claim 4, wherein, in an instance in which the difference between the first and second orbital coordinates, the difference between the first and second velocities or the difference between the first and second clock offsets fails to satisfy the respective threshold, generating or providing information comprises providing the information regarding the quality of the correction data to a correction service that provides the first and second correction data.

6. A method according to claim 1, wherein predicting the one or more of the first orbital coordinates, the first velocity or the first clock offset comprises predicting the at least one of the first orbital coordinates, the first velocity or the first clock offset additionally based upon one or more of Earth orientation parameters, antenna phase center offsets or solar-radiation pressure parameters.

7. An apparatus configured to monitor a quality of correction data, the apparatus comprising processing circuitry and at least one non-transitory memory including computer program code instructions stored therein, the computer program code instructions configured to, when executed by the processing circuitry, cause the apparatus at least to:
predict one or more of first orbital coordinates, a first velocity or a first clock offset of a navigation satellite based upon prior navigation data and prior correction data;
derive one or more of second orbital coordinates, a second velocity or a second clock offset of the navigation satellite based upon second navigation data and second correction data, wherein the second navigation data and second correction data are more recent than the prior navigation data and prior correction data;
compare at least one of the first orbital coordinates, the first velocity or the first clock offset to at least one of the second orbital coordinates, the second velocity or the second clock offset, respectively; and
based on a comparison of the at least one of the first orbital coordinates, the first velocity or the first clock offset to the at least one of the second orbital coordinates, the second velocity or the second clock offset, respectively, generate or provide information regarding the quality of the correction data.

8. An apparatus according to claim 7, wherein the prior navigation data and the prior correction data are associated with a first time, and wherein the computer program code instructions are configured to, when executed by the processing circuitry, cause the apparatus to predict one or more of the first orbital coordinates, the first velocity or the first clock offset for a time subsequent to the first time.

9. An apparatus according to claim 7, wherein the at least one of the first orbital coordinates, the first velocity or the first clock offset are predicted for the same time for which the one or more of the second orbital coordinates, the second velocity or the second clock offset are derived.

10. An apparatus according to claim 7, wherein the computer program code instructions are configured to, when executed by the processing circuitry, cause the apparatus to compare by comparing one or more of a difference between the first and second orbital coordinates, a difference between the first and second velocities or a difference between the first and second clock offsets to respective thresholds.

11. An apparatus according to claim 10, wherein the computer program code instructions are configured to, when executed by the processing circuitry, cause the apparatus to, in an instance in which the difference between the first and second orbital coordinates, the difference between the first and second velocities or the difference between the first and second clock offsets fails to satisfy the respective threshold, generate or provide information by providing the information regarding the quality of the correction data to a correction service that provides the first and second correction data.

12. An apparatus according to claim 7, wherein the computer program code instructions are configured to, when executed by the processing circuitry, cause the apparatus to predict the one or more of the first orbital coordinates, the first velocity or the first clock offset by predicting the at least one of the first orbital coordinates, the first velocity or the first clock offset additionally based upon one or more of Earth orientation parameters, antenna phase center offsets or solar-radiation pressure parameters.

13. A method for monitoring a quality of correction data, the method comprising:
predicting one or more first parameters associated with a navigation satellite or propagation of signals transmitted by the navigation satellite based upon prior data including prior correction data associated with the navigation satellite or the propagation of signals transmitted by the navigation satellite;
deriving one or more second parameters associated with the navigation satellite or the propagation of signals transmitted by the navigation satellite based upon second data including second correction data associated with the navigation satellite or the propagation of signals transmitted by the navigation satellite, wherein the second data including the second correction data is more recent than the prior data including the prior correction data;
comparing at least one of the one or more first parameters to at least one of the one or more second parameters; and
based on the comparing, generating or providing information regarding the quality of the correction data.

14. A method according to claim 13, wherein the one or more first parameters comprise one or more of first orbital coordinates, a first velocity or a first clock offset of the navigation satellite based upon prior navigation data and the prior correction data, and wherein the one or more second parameters comprise one or more of second orbital coordinates, a second velocity or a second clock offset of the navigation satellite based upon second navigation data and the second correction data.

15. A method according to claim 13, wherein the first and second correction data comprise correction data for one or more of orbit corrections, clock corrections, code bias corrections, phase bias corrections, ionospheric model corrections or tropospheric model corrections.

16. A method according to claim 13, wherein the prior data including the prior correction data are associated with a first time, and wherein predicting one or more first parameters comprises predicting one or more first parameters for a time subsequent to the first time.

17. A method according to claim 13, wherein the at least one of the one or more first parameters that are compared to the at least one of the one or more second parameters are predicted for the same time for which the one or more second parameters are derived.

18. A method according to claim 13, wherein the comparing comprises comparing one or more of a difference between the first and second parameters to a respective threshold.

19. A method according to claim 18, wherein, in an instance in which the difference between the first and second parameters fails to satisfy the respective threshold, generating or providing information comprises providing the information regarding the quality of the correction data to a correction service that provides the first and second correction data.

20. A method according to claim 13, wherein predicting the one or more first parameters comprises predicting the one or more first parameters additionally based upon one or more of Earth orientation parameters, antenna phase center offsets or solar-radiation pressure parameters.
